(19) United States
(12) Patent Application Publication
(10) Pub. No.: US 2026/0181630 A1
(43) Pub. Date: Jun. 25, 2026

(54) CONFIGURED GRANT WITH MULTIPLE TRANSMISSION OCCASIONS

(71) Applicant: Lenovo (Singapore) Pte. Ltd., Singapore (SG)

(72) Inventors: Hossein Bagheri, Dearborn Heights, MI (US); Vijay Nangia, Woodridge, IL (US); Joachim Löhr, Wiesbaden (DE)

(21) Appl. No.: 19/127,013

(22) PCT Filed: Nov. 2, 2023
(86) PCT No.: PCT/IB2023/061092

§ 371 Date: May 2, 2025

Related U.S. Application Data
(60) Provisional application No. 63/421,956, filed on Nov. 2, 2022.

(51) Int. Cl. H04W 72/1268; H04W 72/566

(52) U.S. Cl. CPC H04W 72/1268; H04W 72/566

(57) ABSTRACT

Various aspects of the present disclosure relate to a Configured Grant (CG) with multiple transmission occasions. A UE may be configured to receive a CG configuration for UL transmissions in periodic UL resources corresponding to a plurality of CG periods. The UE may be configured to determine a first set of the plurality of CG periods, wherein a respective UL resource in a CG period of the first set of the plurality of CG periods comprises a plurality of Physical Uplink Shared Channel (PUSCH) transmission occasions, and wherein at least one CG period of a remainder of the plurality of CG periods comprises a single PUSCH transmission occasion. The UE may be configured to transmit a transport block (TB) in a particular PUSCH transmission occasion.

### TECHNICAL FIELD

The present disclosure relates to wireless communications, and more specifically to schemes for configured grant (CG) with multiple transmission occasions.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE comprising a means for receiving a CG configuration for uplink (UL) transmissions in periodic UL resources corresponding to a plurality of CG periods. The UE described herein may further comprise a means for determining a first set of the plurality of CG periods, where a respective UL resource in a respective CG period of the first set of the plurality of CG periods comprises a plurality of Physical Uplink Shared Channel (PUSCH) transmission occasions, where at least one CG period of a remainder of the plurality of CG periods comprises a single PUSCH transmission occasion. The UE described herein may further comprise a means for transmitting a transport block (TB) in a particular PUSCH transmission occasion.

Some implementations of the method and apparatuses described herein may include a base station comprising a means for transmitting, to a UE, a CG configuration for UL transmissions in periodic UL resources corresponding to a plurality of CG periods, where the CG configuration comprises a first set of the plurality of CG periods, where a respective UL resource in a respective CG period of the first set of the plurality of CG periods comprises a plurality of PUSCH transmission occasions, where at least one CG period of a remainder of the plurality of CG periods comprises a single PUSCH transmission occasion. The base station described herein may further comprise a means for receiving, from the UE, a TB in a particular PUSCH transmission occasion.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a super CG configuration with 50 ms periodicity comprising three CG configurations, in accordance with aspects of the present disclosure.

FIG. 4A illustrates an example of a variable extended Reality (XR) frame size and semi-statically configured CG resource, in accordance with aspects of the present disclosure.

FIG. 4B illustrates another example of a variable XR frame size and semi-statically configured CG resource, in accordance with aspects of the present disclosure.

FIG. 5 illustrates an example of a scenario for indicating unused PUSCH transmission occasions within a CG period, in accordance with aspects of the present disclosure.

FIG. 6 illustrates an example of a procedure for transmission using a CG configuration having multiple PUSCH transmission occasions within a particular CG period, in accordance with aspects of the present disclosure.

FIG. 7 illustrates an example of a timeline for multiplexing Uplink Control Information (UCI), in accordance with aspects of the present disclosure.

FIG. 8 illustrates an example of a super CG configuration, in accordance with aspects of the present disclosure.

FIG. 9 illustrates an example of a timeline for overlap handling, in accordance with aspects of the present disclosure.

FIG. 10 illustrates an example of a user equipment (UE) 1000, in accordance with aspects of the present disclosure.

FIG. 11 illustrates an example of a processor 1100, in accordance with aspects of the present disclosure.

FIG. 12 illustrates an example of a network equipment (NE) 1200, in accordance with aspects of the present disclosure.

FIG. 13 illustrates a flowchart of a first method performed by a UE, in accordance with aspects of the present disclosure.

FIG. 14 illustrates a flowchart of a second method performed by a NE, in accordance with aspects of the present disclosure.

### DETAILED DESCRIPTION

Generally, the present disclosure describes systems, methods, and apparatuses for supporting a configured grant (CG) with multiple transmission occasions, e.g., for e Xtended Reality (XR) service. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

XR is an umbrella term for different types of realities including Virtual Reality (VR), Augmented Reality (AR), and Mixed Reality (MR). XR refers to all real-and-virtual combined environments and human-machine interactions generated by computer technology and wearables.

UL XR traffic may occur almost periodically (with small jitter) with varying video frame size from one frame to another. Once the radio access network (RAN) knows a video frame has arrived in the buffer of a UE, it could perform dynamic scheduling to assign proper number of resources to the UE for transmitting the video frame. Typically, such dynamic scheduling may incur scheduling delay e.g., due to Scheduling Request (SR) and Buffer Status Report (BSR) transmission delays, particularly, in heavy Downlink (DL) Time Division Duplex (TDD) setup (i.e., DL slots/symbols in between UL slots/symbols). Such a delay may not be desirable due to PDU-set delay bound (PSDB) requirements for XR video frames.

Configured Grant (CG) UL transmissions could be used to convey video frames to the RAN. However, CG has fixed resources (e.g., certain number of PUSCH transmission occasions, with each PUSCH transmission occasion comprising a fixed number of Resource Elements (REs)) in each period whereas video frame size is varying from one period to another period. Hence, to avoid/reduce resource wastage, the UE may indicate the unused CG resources to the RAN, so that the RAN may schedule other UEs in those resources.

The present disclosure provides details of such indications and associated mechanisms to reduce/avoid resource wastage. In particular, the following aspects are elaborated. In accordance with certain aspects of the present disclosure, Configured Grant Uplink Control Information (CG-UCI) may be used to indicate unused CG resources, e.g., unused PUSCH transmission occasions within a CG period. In accordance with certain aspects of the present disclosure, a Medium Access Control (MAC) Control Element (CE) may be used to indicate unused CG resources, e.g., unused PUSCH transmission occasions within a CG period. In accordance with certain aspects of the present disclosure, the network may configure a UE with a CG configuration with multiple transmission occasions.

Additionally, the present disclosure describes solutions for overlap handling and conditions and rules for filling at least a part of the unused resources with other UL information such as Channel State Information (CSI), BSR, PHR, etc.

Aspects of the present disclosure are described in the context of a wireless communications system.

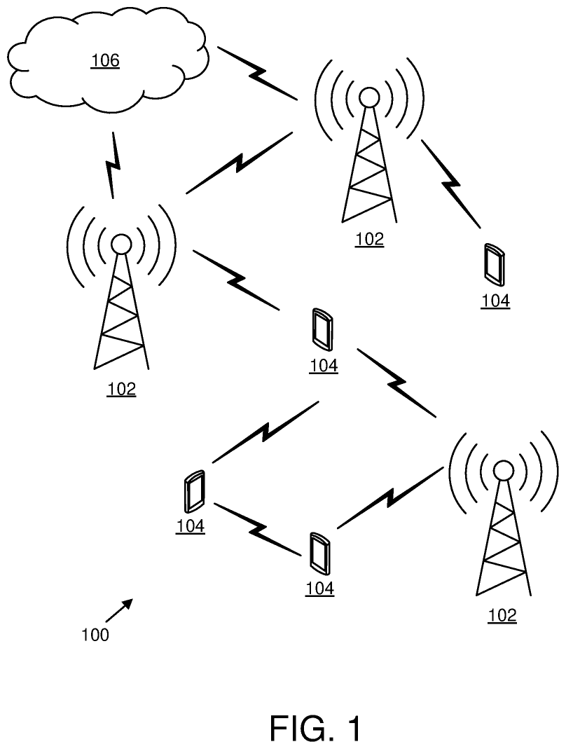

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

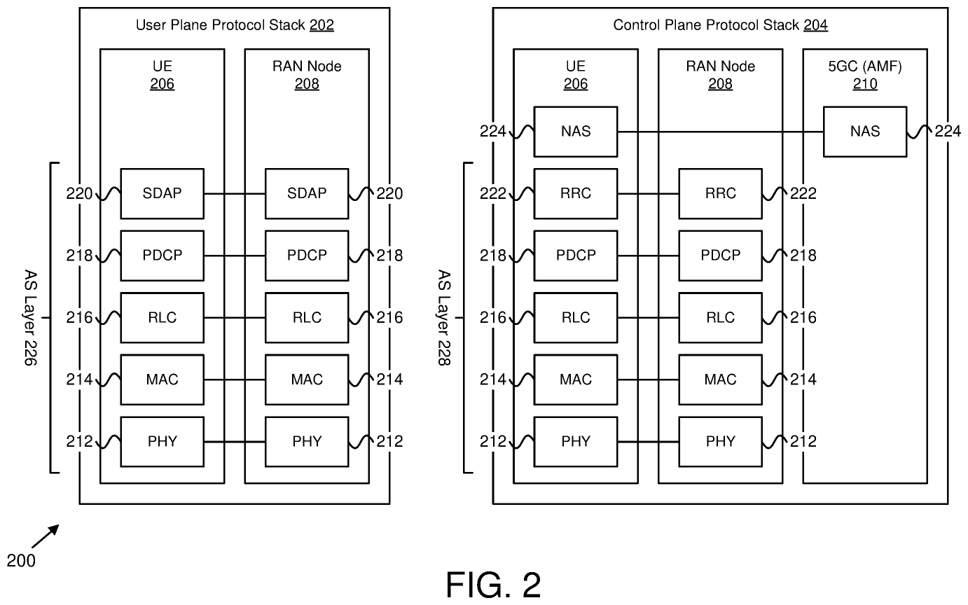

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a Physical (PHY) layer 212, a MAC sublayer 214, a Radio Link Control (RLC) sublayer 216, a Packet Data Convergence Protocol (PDCP) sublayer 218, and a Service Data Adaptation Protocol (SDAP) sublayer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

A service-oriented design considering XR traffic characteristics (e.g., (a) bursty quasi-periodic packets coming at 30-120 frames/second with some jitter, (b) packets having variable and large packet size, (c) B/P-frames being dependent on I-frames, (d) presence of multiple traffic/data flows such as pose (i.e., user orientation/position) and video scene in uplink, (e) various degrees of importance between I/P/B-frames in contributing to the end-to-end quality of user experience) can enable more efficient (e.g., in terms of satisfying XR service requirements for a greater number of UEs, in terms of UE power saving, or in terms of XR traffic reliability and rendering robustness against wireless networks transmissions effects) XR service delivery.

According to 3GPP Technical Report (TR) 26.928, XR is an umbrella term for different types of realities including: VR, AR, and MR. VR is a rendered version of a delivered visual and audio scene. The rendering is designed to mimic the visual and audio sensory stimuli of the real world as naturally as possible to an observer or user as they move within the limits defined by the application.

VR usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. Additional means to interact with the virtual reality simulation may be provided but are not strictly necessary.

AR is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

MR is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many of the XR and CG use cases are characterized by quasi-periodic traffic (with possible jitter) with high data rate in DL (i.e., video steam) combined with the frequent UL (i.e., pose/control update) and/or UL video stream. Both DL and UL traffic are also characterized by a relatively strict Packet Delay Budget (PDB).

The set of anticipated XR and CG services has a certain variety and characteristics of the data streams (i.e., video) may change “on-the-fly”, while the services are running over NR.

Therefore, additional information on the running services from higher layers, e.g., the QoS flow association, frame-level QoS, ADU-based QoS, XR-specific QoS, etc., may be beneficial to facilitate informed choices of radio parameters. It is clear that XR application awareness by UE and gNB would improve the user experience, improve the NR system capacity in supporting XR services, and reduce the UE power consumption.

An Application Data Unit (ADU) is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. An ADU can be one or more I-slices, P-slices, I-frame, P-frame, or a combination of those. As known in the art, there are three major picture types used in the different video algorithms, referred to as I-frames, P-frames, and B-frames. These types are different in the following characteristics: I-frames are the least compressible but do not require other video frames to decode. P-frames can use data from previous frames to decompress and are more compressible than I-frames. B-frames can use both previous and forward frames for data reference to get the highest amount of data compression.

The latency requirement of XR traffic in RAN side (i.e., air interface) is modelled as PDB. The PDB is a limited time budget for a packet to be transmitted over the air from a gNB to a UE.

For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered.

The value of PDB may vary for different applications and traffic types, which can be 10-20 ms depending on the application (see TR 26.926).

5G arrival time of data bursts on the downlink can be quasi periodic i.e. periodic with jitter. Some of the factors leading to jitter in burst arrival include varying server render time, encoder time, Real-time Transport Protocol (RTP) packetization time, link between server and 5G gateway etc. 3GPP agreed simulation assumptions for XR evaluation model DL traffic arrival jitter using truncated Gaussian distribution with mean: Oms, std. dev: 2 ms, range: [−4 ms, 4 ms] (baseline), [−5 ms, 5 ms] (optional).

Applications can have a certain delay requirement on an ADU, that may not be adequately translated into packet delay budget requirements. For example, if the ADU Delay Budget (ADB) is 10 ms, then PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU. It is observed that specifying the ADB to the 5G system can be beneficial.

With regard to delay-aware communication, if the scheduler, and/or the UE is aware of delay budgets for a packet/ADU, the gNB can take this knowledge into account in scheduling transmissions, e.g., by giving priority to transmissions close to their delay budget limit, and by not scheduling (e.g., UL) transmissions; the UE can also take advantage of such knowledge to determine 1) if an UL transmission (e.g., physical uplink control channel (PUCCH) in response to physical downlink shared channel (PDSCH), UL pose, or physical uplink shared channel (PUSCH)) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the gNB.

The remaining delay budget 1) for a DL transmission can be indicated to the UE in a Downlink Control Information (DCI) (e.g., for a packet of a video frame/slice/ADU) or via a MAC-CE (e.g., for an ADU/video frame/slice) and 2) for an UL transmission can be indicated to the gNB via an UL transmission such as UCI, PUSCH transmission, etc.

3GPP TDoc R1-2112207 (“PDSCH and PUSCH enhancements for 52.6-71 GHz band”) discusses ADU-related QoS aspects of XR that can be conveyed to the RAN to optimize the communication such as ADU Error Rate (AER), ADB, and ADU content policy (referred to as “ADP”, which is a percentage of packets/bits of an ADU to be received in order to correctly decode the ADU).

With regard to the jitter aspects of XR traffic, the packet arrival rate is determined by the XR application frame generation rate, e.g., 30/60/90/120 frames-per-second (fps). Accordingly, the average packet arrival periodicity is given by the inverse of the frame rate, e.g., 16.6667 ms= 1/60 fps. Thus, the periodic arrival time without jitter at the gNB of XR packets indexed by k=1, 2, 3, . . . is

$${τ}_{k} = \frac{k}{F} \cdot 1000 [ ms ] , \qquad Equation 1$$

where F denotes the XR application video frame generation rate (per second).

This periodic packet arrival model implicitly assumes fixed delay contributed from network side including fixed video encoding time, fixed network transfer delay, etc.

However, in a real system, the varying frame encoding delay and network transfer time introduces stochastic jitter in packet arrival time at the gNB. Generically, the jitter is modelled as a truncated Gaussian random process resulting into a random variable added on top of periodic arrivals. The jitter contribution to the packet arrival time thus generates an additive truncated Gaussian distribution to the inherent ideal periodicity of the XR DL traffic with statistical parameters according to 3GPP TR 38.838 (v1.0.1) displayed in Table 1, below.

TABLE 1
Statistical parameters for jitter of DL XR traffic

| | | Baseline model | Optional model |
|---|---|---|---|
| | Unit of | value for | value for |
| Parameter | measure | evaluation | evaluation |
| Mean | ms | 0 | |
| Standard deviation | ms | 2 | |
| Truncation range | ms | [−4, 4] | [−5, 5] |

Given the jitter model considered in 3GPP for 5G and beyond radio access networks (RANs), even for high frame generation rates, e.g., 120 fps, the given parameter values and considered frame generation rates ensures in-order packet arrivals (i.e., arrival time of a next packet is always larger than that of the previous packet). Concretely, the XR traffic model of periodic arrival with jitter for an arrival time of a video frame packet with index k=1, 2, 3, . . . is summarized by

$${τ}_{k} = offset + \frac{k}{F} \cdot 1000 + J [ ms ] , \qquad Equation 2$$

where F is the given frame generation rates (per second) and/is the jitter specific random variable following the model of Table 1. Moreover, the actual traffic arrival timing of traffic for each UE could be shifted by the UE-specific, arbitrary value offset.

With regard to BSR, once a BSR is triggered, BSR information is multiplexed in a PUSCH. BSR information indicates how much data associated to one or more Logical Channel Groups (LCGs) is available in the UE's buffer for transmission. There could be several BSR triggering conditions as described in greater detail in the appendix.

Instead of a CG configuration with multiple PUSCH transmission occasions within a period, multiple CG configurations each providing one PUSCH transmission occasion can be used. Currently, up to 12 CG configurations per bandwidth part (BWP) can be active at a time. Multiple PUSCH transmission occasions within a CG are an alternative that does not require multiple activation commands and may be suitable for UEs not supporting many CG configurations. This disclosure provides details of the latter approach (one CG with multiple PUSCH transmission occasions, wherein two PUSCH transmission occasions of a CG period can contain two different TBs). Nonetheless, some aspects of this disclosure are still applicable to the case of multiple CG configurations, each with a single PUSCH transmission occasion, such as proposed techniques in the following sections. More importantly, many proposals in this disclosure can also be applied for the case of multiple CG configurations with single PUSCH transmission occasion per CG configuration with little change.

For instance, a UCI in a PUSCH transmission occasion of one of the CGs can indicate which CGs are unused in a period (e.g., CG2 is used, and CG1, CG3, and CG4 have unused PUSCH transmission occasions), and similar techniques described in this disclosure can be applied such as overlap handling aspects described below, wherein another UL transmission can occur in unused PUSCH transmission occasions belonging to different CG configurations (e.g., CG1, CG3, and CG4).

In certain embodiments, a non-uniform CG pattern may be used to approximately align the CG resources with XR traffic arrival as described below. Each of the CG periods, associated with the CG configurations within a super CG period, can comprise multiple PUSCH transmission occasions, and there may not be a need to have some of the periods comprising multiple PUSCH transmission occasions and some comprising only one PUSCH transmission occasion as described in the below solutions.

Nevertheless, some aspects of this disclosure still are applicable to the case of non-uniform CG pattern with multiple PUSCH transmission occasions, such as some of the proposed techniques described in the below solutions.

For XR service, the packet arrival rate is determined by the frame generation rate, e.g., 60 fps equals to 16.6667 ms, which is not aligned with the integer CG periodicity configuration. There are several implementation methods, e.g., multiple CG configurations to address the alignment issue. But this is not an efficient way and considering that the number of CG configurations is limited, and the limited multiple CG configurations maybe needed to realize variable packet size for XR traffic, some enhancements for one CG configuration could be considered to realize the non-integer periodicity for CG transmissions.

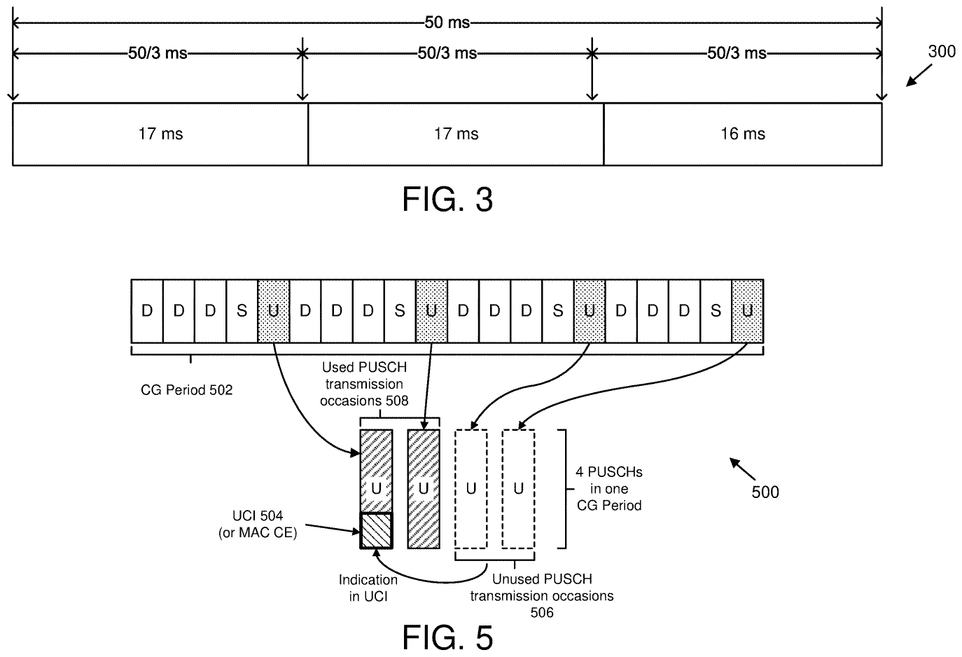

FIG. 3 depicts an exemplary super CG configuration 300 comprising three CG configurations, in accordance with aspects of the present disclosure. Assuming XR traffic periodicity is 1000/60=50/3 ms, a longer periodicity with three smaller periodicities, e.g., 50 ms=(17 ms, 17 ms, 16 ms), could be configured for one CG configuration, and then a long periodicity cycle of 50 ms could be obtained and the alignment between XR traffic and CG could be achieved.

Large video frame sizes may require more than one PUSCH transmission occasion to be transmitted. For example, 1-5 PUSCH transmission occasions per video frame may be needed depending on the channel condition and the video frame size. One way is to configure multiple PUSCH transmission occasions within a CG period. In one embodiment, a set of allowed periodicities P is predetermined, e.g., defined by specification.

In certain embodiments, a higher layer parameter, e.g., cg-nrofSlots, provides the number of consecutive slots allocated within a configured grant period. In certain embodiments, a higher layer parameter, e.g., cg-nrofPUSCH-InSlot, provides the number of consecutive PUSCH allocations within a slot, where the first PUSCH allocation follows the higher layer parameter timeDomainAllocation for Type 1 PUSCH transmission or the higher layer configuration according to 3GPP Technical Specification (TS) 38.321, and UL grant received on the DCI for Type 2 PUSCH transmissions, and the remaining PUSCH allocations have the same length and PUSCH mapping type, and are appended following the previous allocations without any gaps. The same combination of start symbol and length and PUSCH mapping type repeats over the consecutively allocated slots.

However, the CG resource is semi-statically configured, and cannot adapt to the varying size of XR frames. If the amount of configured resources is not sufficient for transmission of an XR frame, some scheduling delay associated with the dynamic scheduling could occur for scheduling the rest of the video frame that could not be fit in the configured resources.

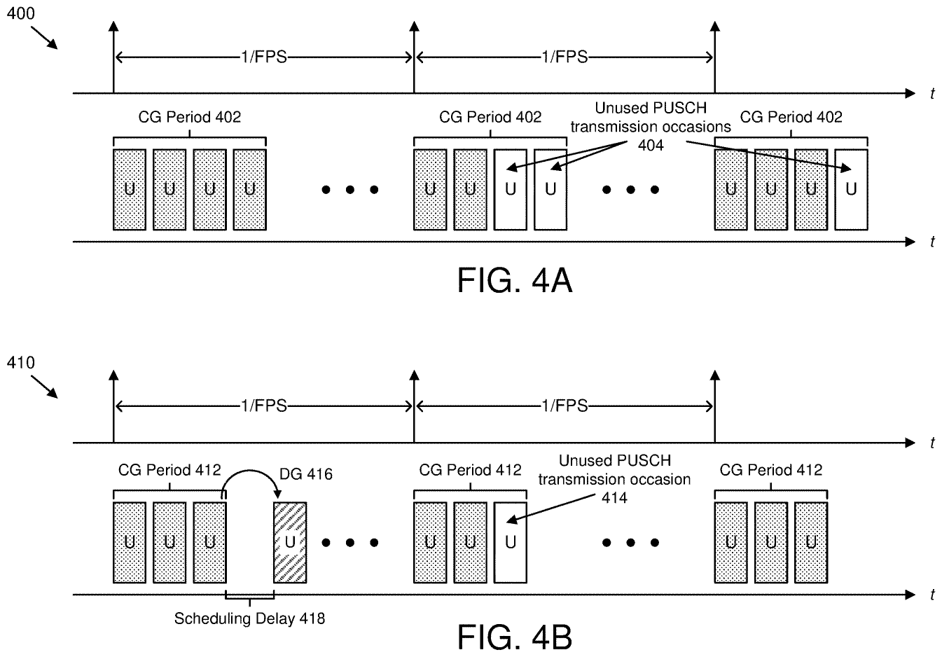

FIGS. 4A-4B illustrate examples of semi-static configurations of CG resources, in accordance with aspects of the present disclosure. FIG. 4A depicts a first configuration 400 where four PUSCH transmission occasions are configured in one CG period 402. In the first configuration 400, there is potential for resource waste (due to unused PUSCH transmission occasions 404) for any video frames that need less than four PUSCH transmission occasions.

FIG. 4B depicts a second configuration 410 where only three PUSCH are configured in one CG period 412. In the second configuration 410, there is less risk of resource waste due to unused PUSCH transmission occasions 414 as compared to the first configuration 400. However, if a particular video frame is large for the configured CG resources, e.g., if four PUSCH transmission occasions are required, then additional dynamic scheduling is needed (see dynamic grant (DG) 416, resulting in extra delay, i.e., scheduling delay 418.

FIG. 5 depicts an exemplary scenario 500 for indicating to gNB the unused PUSCH transmission occasions 506 within one CG period 502. In order to avoid the extra delay caused by additional dynamic scheduling, the CG resource within one CG period 502 should be configured according to a relatively large size of XR frame. Upon arrival of a video frame, the UE can determine how many resources out of the configured resources within one CG period are needed (e.g., used PUSCH transmission occasions 508) and could indicate the amount of unused resources (e.g., unused PUSCH transmission occasions 506) to the gNB so that the gNB could schedule other UL transmissions (for the same UE or a different UE) in at least some of the unused resources. The indication could be via UCI 504 or MAC CE and could be transmitted in the first CG PUSCH transmission occasion.

In various embodiments, a UE may be configured with a CG configuration having multiple PUSCH transmission occasions within a particular CG period.

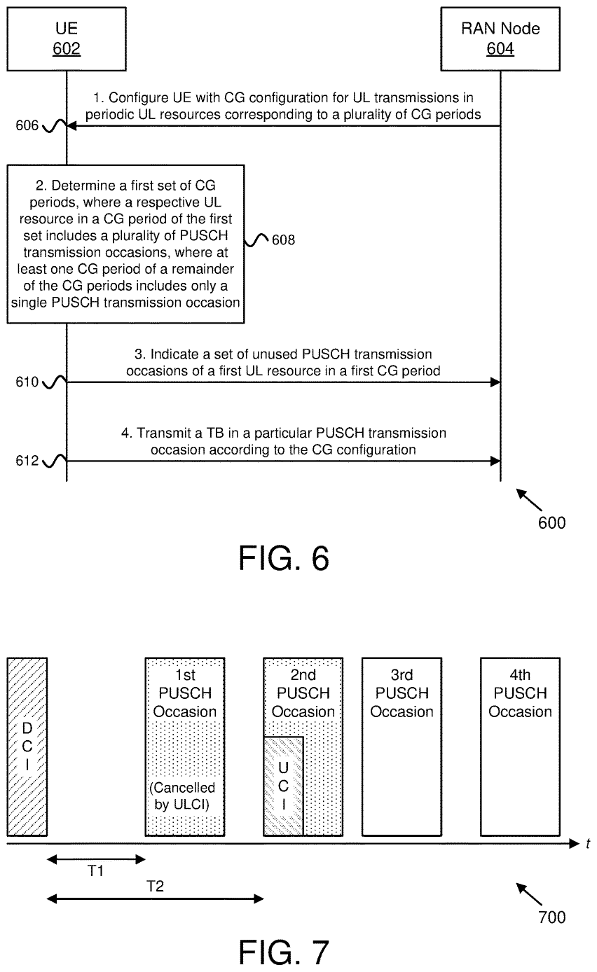

FIG. 6 depicts an exemplary procedure 600 for transmission using a CG configuration having multiple PUSCH transmission occasions within a particular CG period, in accordance with aspects of the present disclosure. The procedure 600 involves a UE 602 (e.g., an embodiment of the UE 104 and/or the UE 206) and a RAN node 604 (e.g., a gNB and/or an embodiment of the NE 102 and/or RAN entity 208).

At Step 1, the RAN node 604 configures the UE 602 with a CG configuration for UL transmission in periodic UL resources corresponding to a plurality of CG periods (see messaging 606).

At Step 2, the UE 602 determines a first set of CG periods (see block 608). Here, a respective UL resource in a CG period of the first set includes a plurality of PUSCH transmission occasions, where at least one CG period of a remainder of the CG periods includes only a single PUSCH transmission occasion.

At Step 3, the UE 602 indicates, to the RAN node 604, a set of unused PUSCH transmission occasions of a first UL resource in a first CG period (see messaging 610).

At Step 4, the UE 602 transmits a TB in a particular PUSCH transmission occasion according to the CG configuration (see messaging 612). Note that the indication in Step 3 may be a UCI that is multiplexed into the PUSCH transmission associated with the TB of Step 4, e.g., as depicted in FIG. 5.

According to embodiments of a first solution, the UE 602 uses CG-UCI to indicate unused CG resources, e.g., unused PUSCH transmission occasions within a CG period. In some embodiments, the CG-UCI (or a new UCI carrying the unused CG resource/occasion information) can indicate the unused CG resources and/or unused PUSCH transmission occasions. In the following details of such design are provided.

In various embodiments of the first solution, one or more of the following implementations may be applied:

In a first implementation of the first solution, the CG-UCI indicates unused nominal PUSCH transmission occasions. A nominal PUSCH transmission occasion may comprise one or more actual PUSCH transmission occasions, where an actual PUSCH transmission occasion can carry the initial transmission or repetition of a TB associated with the nominal PUSCH transmission occasion. A nominal PUSCH transmission occasion may be composed of one or multiple actual PUSCH transmission occasions. One or more DL symbols in between UL symbols of a nominal PUSCH transmission occasion can create one or more actual PUSCH transmission occasions associated with the nominal PUSCH transmission occasion. There is no DL symbol in between UL symbols of an actual PUSCH transmission occasion, i.e., the UL symbols of an actual PUSCH transmission occasion are contiguous.

In a second implementation of the first solution, the CG-UCI may indicate the number of nominal PUSCH transmission occasions within the associated CG period, e.g., in case different CG periods of the CG configuration have different number of CG PUSCH transmission occasions, as described in greater detail below with regard to the third solution.

In a third implementation of the first solution, the CG-UCI is multiplexed in the first actual repetition of the first nominal PUSCH transmission occasion.

In a fourth implementation of the first solution, the CG-UCI is indicated in all or a subset of the nominal PUSCH transmission occasions of a CG period of a CG configuration. The subset comprises all the PUSCH transmission occasions except the last ‘K’ PUSCH transmission occasions. In one embodiment, ‘K’=1. In another embodiment, ‘K’ is configured. For example, ‘K’ may be configured per CG configuration or per Subcarrier Spacing (SCS) or per Logical Channel Group (LCG). Doing so improves PUSCH capacity/reliability in case a PUSCH transmission occasion of the ‘K’ last PUSCH transmission occasions is used for PUSCH transmission.

In certain embodiments, resource savings due to such indication may not bring significant resource saving if an insufficient number of PUSCH transmission occasions can be indicated to be unused. Accordingly, the UE may indicate unused PUSCH transmission occasions only if a threshold number of PUSCH transmission occasions are to be indicated as unused. For example, if only one PUSCH transmission occasion exists in the period, then for ‘K’=1, there is no PUSCH transmission occasion to be indicated unused. Even if the first PUSCH transmission occasion is cancelled and there are only two PUSCH transmission occasions in the period, the last K=1 occasion would not have UCI multiplexed. The subset of nominal PUSCH transmission occasions carrying the UCI indication can be determined based on a configured/indicated bitmap.

In certain embodiments of the fourth implementation, if CG-UCI is transmitted in multiple PUSCH transmission occasions, the UE is not expected to be provided different number of unused PUSCH transmission occasions in different PUSCH transmission occasions that CG-UCI is sent (i.e., the information conveyed by multiple CG-UCIs are consistent). The video frame/packet may come in a later PUSCH transmission occasion of the PUSCH transmission occasions of a period.

In such a case, CG-UCI is still to be indicated in pre-determined PUSCH transmission occasions. For instance, if there are four PUSCH transmission occasions within a CG period, only the first and the third PUSCH transmission occasions can carry the UCI indication. If the packet transmission starts from the second PUSCH transmission occasion (i.e., the first PUSCH transmission occasion in not used), the UCI indication only appears in the third PUSCH transmission occasion. In other words, the second used PUSCH transmission occasion carries the UCI since the first PUSCH transmission occasion of the 4-PUSCH transmission occasions is not used.

In a fifth implementation of the first solution, the CG-UCI has an m-bit field indicating up to (2^{m})−1 nominal PUSCH transmission occasions (from a reference PUSCH transmission occasion or a reference time, e.g., the reference PUSCH transmission occasion could be the last PUSCH transmission occasion of the PUSCH transmission occasions within the CG period) to be unused. One code point in the bit-filed indicates there is no unused PUSCH transmission occasion, or the information is not available. In one example, the value of the m-bit field indicates the number of unused PUSCH transmission occasions starting from the last PUSCH transmission occasion. In certain embodiments, ‘m’ is determined based on the number of PUSCH transmission occasions (‘N’) within a CG period of the CG configuration. As an example, the value of ‘m’ may be calculated using the equation: m=ceil(log 2(N)).

In a sixth implementation of the first solution, the CG-UCI has an m-bit field indicating ‘2^{m}’ groups of PUSCH transmission occasions (‘m’ is configured); the UE groups the ‘N’ occasions to ‘2^{m}’ groups and determines which ones are not used based on the indication. For instance, if there are ‘N’=8 PUSCH transmission occasions, and ‘m’=2; if CG-UCI indicates ‘10’ in the 2-bit field, the gNB assumes the last two groups of PUSCH transmission occasions are unused (i.e., the last four PUSCH transmission occasions, since each group has two PUSCH transmission occasions). In one example, the value of the m-bit field indicates the number of unused PUSCH transmission occasion groups starting from the last PUSCH transmission occasion group.

In a seventh implementation of the first solution, the CG-UCI indicates an amount of data in the UE's buffer. In one embodiment of the seventh implementation, the indication may indicate a fraction or a multiple with respect to a reference amount of data. Here, the reference amount of data may be configured by the network (e.g., gNB). In one example, the reference amount may be based on the number of resources (e.g., number of REs, Transport Block Size (TBS), etc.) configured for a CG PUSCH transmission occasion.

In another embodiment of the seventh implementation, the indication may indicate a multiple/scaling factor with respect to number of PUSCH transmission occasions ‘N’ or with respect to the amount of data that can be fit in one or in ‘N’ PUSCH transmission occasions.

In yet another embodiment of the seventh implementation, the indication may indicate an index from a BSR table (e.g., a 5-bit BSR table or an 8-bit BSR table). Here, the indication may indicate an entry from a subset of entries of a BSR table (e.g., last ‘X’ entries; wherein ‘X’ can be configured or determined based on a size of a field in the indication).

In an eighth implementation of the first solution, the UE is not expected to provide the UCI if BSR is included in the first PUSCH transmission occasion of the ‘N’ PUSCH transmission occasions.

In a ninth implementation of the first solution, the UE is not expected to provide the UCI indicating at least one PUSCH transmission occasion is unused when a BSR included in one of the PUSCH transmission occasions indicates an amount of UL data that should occupy—at least partially—the indicated unused PUSCH transmission occasions. For instance, if the UCI indicates the last PUSCH transmission occasion is unused, the UE is not expected to indicate a BSR, wherein the amount of indicated resources in the BSR needs the last PUSCH transmission occasion to be used. Alternatively or additionally, the UE is not expected to provide the UCI indicating no PUSCH transmission occasion is unused when a BSR included in one of the PUSCH transmission occasions indicates at least one PUSCH transmission occasion can be unused.

In a tenth implementation of the first solution, the UE is not expected to provide a BSR in a PUSCH transmission occasion of the PUSCH transmission occasions of a CG period, if the UE indicates the indication of unused PUSCH transmission occasions. Alternatively, if a BSR has been triggered, the triggered BSR is canceled upon such indication of unused resources.

In an eleventh implementation of the first solution, if the first PUSCH transmission occasion is cancelled, e.g., due to reception of Slot Format Indicator (SFI), Uplink Cancellation Indication (ULCI), dynamic scheduling of DL channel/signal(s) on flexible symbol(s), the UCI is multiplexed on the next available PUSCH transmission occasion if a timeline is satisfied.

In certain embodiments of the eleventh implementation, the timeline is determined from the cancellation timeline (e.g., ULCI timeline from the reception of the cancellation signaling) and an offset. In one embodiment, the offset may be RRC configured and can be configured per SCS.

FIG. 7 depicts an exemplary timeline 700 for multiplexing UCI, in accordance with aspects of the present disclosure. In the exemplary timeline 700, a DCI cancels the first PUSCH transmission occasion, and the UCI (i.e., indicating unused PUSCH transmission occasions) is multiplexed in the second PUSCH transmission occasion if the DCI has been sent T1+d time units (e.g., symbols) prior to a time reference (the time reference in the figure is the start of the second PUSCH transmission occasion). Here, ‘T1’ is the minimum time required for a UE (e.g., the UE 602) to cancel the first occasion and ‘d’ is a positive offset that can be configured or indicated by a UE capability report. Accordingly, UCI is multiplexed in the second PUSCH transmission occasion if ‘T2>=T1+d’; wherein the DCI cancels the first PUSCH transmission occasion. Note that the third and fourth PUSCH transmission occasions are unused. The UE indicates to the network that these PUSCH transmission occasions are unused via the UCI.

In a twelfth implementation of the first solution, the UE multiplexes CG-UCI in PUSCH transmission occasions in a first subset of PUSCH transmission occasions (e.g., first PUSCH transmission occasion) according to a first set of CG parameters and in a second subset of PUSCH transmission occasions (e.g., rest of PUSCH transmission occasions) according to a second set of CG parameters, wherein the first set and the second set are different. For instance, the first CG-UCI/UCI in the first PUSCH transmission occasion indicates the unused PUSCH transmission occasions whereas the second CG-UCI/UCI in the last PUSCH transmission occasion would not indicate the unused PUSCH transmission occasions. The UE multiplexes the first CG-UCI/UCI and the second CG-UCI/UCI differently.

In one example of the twelfth implementation, existing CG-UCI can be jointly encoded with a UCI indicating unused resources/PUSCH transmission occasions e.g., based on an RRC configuration parameter.

In another example of the twelfth implementation, CG-UCI including the indication of unused PUSCH transmission occasions is jointly encoded with Hybrid Automatic Repeat Request (HARQ) feedback (also referred to as “HARQ-ACK”) of a PUCCH that overlapped with a PUSCH transmission occasion carrying the CG-UCI based on a first configuration parameter.

Note, however, that CG-UCI which does not include the indication of unused PUSCH transmission occasions is jointly encoded with HARQ-ACK of a PUCCH that overlapped with a PUSCH transmission occasion carrying the CG-UCI based on a second configuration parameter.

According to embodiments of a second solution, the UE 602 may receive a CG configuration with multiple transmission occasions. In various embodiments, a CG configuration may enable a first number of PUSCH transmission occasions in a first period and a second number of PUSCH transmission occasions in a second period, wherein the second number is smaller than the first number.

In one implementation of the second solution, if an XR video frame is available to be transmitted in the first period and no video frame is available to be transmitted in the second period, then the first period may comprise multiple PUSCH transmission occasions to accommodate the video frame, and the second period comprises single PUSCH transmission occasion.

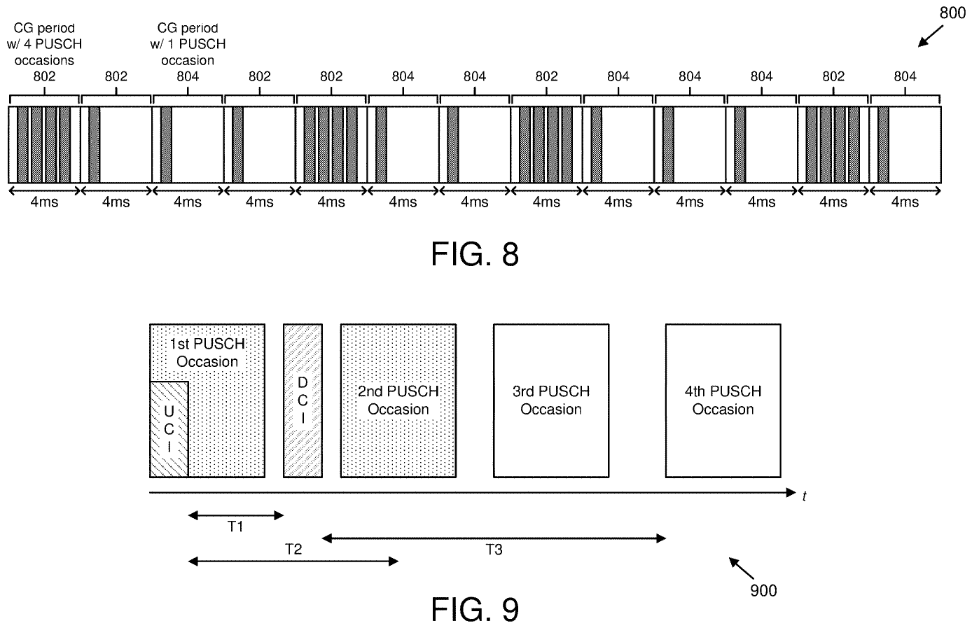

FIG. 8 depicts a super CG configuration 800, in accordance with aspects of the present disclosure. In super CG configuration 800, a UE (e.g., the UE 602) is configured with a CG configuration with 4 ms periodicity, wherein every 3 or 4 periods, a CG period 802 has 4 PUSCH transmission occasions in the period, otherwise, a CG period 804 has one PUSCH transmission occasion in the period. The CG periods 802 with more than one PUSCH transmission occasions can be determined according to video-frame arrivals or based on a semi-statically determined pattern, such as an RRC configured bitmap. In one embodiment, the configured bitmap could be determined based on video-frame arrival rate, and maximum tolerable delay from packet arrival.

Given the CG configuration, and knowledge of video frame arrival, the UE determines the CG period having the least delay compared to the expected video frame arrival and determines that the CG period comprises multiple PUSCH transmission occasions.

Beneficially, locations of unused occasions in CG periods with one PUSCH transmission occasion can be known a priori, which potentially provides more chance for the network to schedule other UEs in other PUSCH transmission occasions if the CG period had multiple PUSCH transmission occasions compared to the case that all CG periods contain multiple PUSCH transmission occasions and the first PUSCH transmission occasion indicates whether the rest of occasions are unused.

Embodiments of a third solution describe overlap handling for a CG configuration with multiple PUSCH transmission occasions. If in a CG period, then the UE indicates some of the PUSCH transmission occasions are unused, the network may schedule other UL transmissions colliding with unused PUSCH transmission occasions, such as PUSCH or PUCCH for the UE at least when certain timeline is satisfied.

In one embodiment of the third solution, the UE via a first indication, indicates unused PUSCH transmission occasions within a CG period of a CG configuration. The UE receives a DCI scheduling/enabling an UL transmission in at least one of the indicated unused PUSCH transmission occasions. The UE transmits the UL transmission if the DCI is received no earlier than a first threshold time after the transmission of the first indication, wherein the first threshold time is determined based on, e.g., a processing capability or the time gNB needs to decode the first indication and schedule the UL transmission, or based on an offset (e.g., with respect to the end of a PUSCH transmission occasion or the offset being configured by higher layers).

In one example, the UE transmits the UL transmission if the UL transmission is not to be sent later than a second threshold time after the transmission of the first indication. In another example, the UE transmits the UL transmission if the scheduling DCI is received no later than a third threshold time before the start of the transmission occasion overlapping with the UL transmission.

FIG. 9 depicts an exemplary timeline 900 for overlap handling, in accordance with aspects of the present disclosure. According to the timeline 900, the UE indicates (to the network) via a UCI multiplexed in the first PUSCH transmission occasion that the last two PUSCH transmission occasions are unused. The network schedules an UL transmission (such as PUCCH in response to a scheduled DL transmission) in the last PUSCH transmission occasion; the UE transmits the UL transmission (e.g., the PUCCH) if the DCI scheduling the UL transmission (e.g., PUCCH) has been sent no later than ‘T2’ from the UCI, and/or the UE does not expect receiving the DCI earlier than ‘T1’, and/or the DCI scheduling the UL transmission (e.g., PUCCH) has been sent no later than ‘T3’ from the start of the last (i.e., 4th) PUSCH transmission occasion. Accordingly, in an example, a DCI within a window defined by T1 and T2 can schedule an UL transmission in an unused PUSCH transmission occasion.

In another embodiment of the third solution, the UE determines a low-priority UL resource overlaps with a high priority CG resource. Here, the UE determines if the high priority UL resource is going to be used for transmission of a high priority information. In response to determining that the high priority UL resource is not going to be used for transmission of a high priority information, the UE may indicate, via a first indication (i.e., CG-UCI), that the high priority UL resource is unused.

Additionally, the UE may transmit a low-priority signal/information in the low-priority UL resource colliding with the unused PUSCH transmission occasion if the first indication is sent at least ‘T’ time units prior to the low-priority resource. In an example, ‘T’ is determined at least based on a PUSCH preparation time ‘N2’ e.g., as defined in clause 6.4 of 3GPP TS 38.214. In one implementation, the end/start of the first indication is at least ‘T’ time units prior to start/end of the low-priority resource.

Embodiments of the fourth solution describe rules for filling unused PUSCH transmission occasions and/or UL resources in a CG period. According to the fourth solution, if there are unused PUSCH transmission occasions in a respective CG period, then the UE may autonomously fill at least part of those resources with some useful information such as CSI.

In some embodiments of the fourth solution, the UE is configured with a CG configuration; wherein a CG period of the CG configuration comprises multiple PUSCH transmission occasions. Here, the UE determines that not all of the PUSCH transmission occasions within the CG period are to be used for data transmission. In response to such determination, the UE provides a CSI report according to a configured CSI configuration in at least part of the unused PUSCH transmission occasions.

As an example, the UE may provide the CSI report if the amount of unused resources corresponding to the unused PUSCH transmission occasions is smaller than a first threshold or larger than a second threshold (first threshold being larger than the second threshold). For instance, if there is only one unused PUSCH transmission occasion and the unused PUSCH transmission occasion only comprises 2 or 1 OFDM symbol(s), and less than ‘X’ (e.g., ‘X’=20) Resource Blocks (RBs), the CSI is provided in the unused PUSCH transmission occasion. If there is not much chance for the network to schedule an UL transmission after receiving an indication from the UE indicating a PUSCH transmission occasion within a CG period is unused, it would be beneficial to use the unused resource to convey useful information to the network.

The CSI is provided in the resource(s) of the unused PUSCH transmission occasion if the UE expects to receive DL transmission in near future; e.g., if the UE has received a DL transmission less than ‘T’ time units prior to the start of a PUSCH transmission occasion of the CG period; wherein ‘T’ is determined based on a configuration. The UE indicates the unused PUSCH transmission occasion(s) in the first PUSCH transmission occasion, gNB based on one of the above rules determines that the UE has provided a CSI report according to a known CSI configuration in the unused PUSCH transmission occasion(s). The UE provides the CSI report in the last unused PUSCH transmission occasion. In an example, the CSI is provided if there has been at least one measurement resource associated with the CSI configuration from the time the UE indicates unused resources/PUSCH transmission occasions till the PUSCH occasion in which the CSI is reported.

In other embodiments, other useful information (other than CSI) may fill in the unused resources such as repetition of the TB (if there is enough resources) or a BSR (such as a padding BSR) or a Power Headroom Report (PHR). In some examples, the UE may indicate the type of information transmitted (e.g., TB repetition, BSR, PHR etc.) in the unused resources e.g., together with the indication of the unused PUSCH occasion(s) in the UCI. In an example, the padding BSR is provided in the last/first unused PUSCH occasion.

According to embodiments of a fifth solution, a BSR may be included in a CG resource, where the CG resource is associated with a CG configuration which not necessarily comprise multiple PUSCH transmission occasions within a CG period of the CG configuration. Currently, BSR can be triggered when UL data, for a logical channel which belongs to an LCG, becomes available to the MAC entity and the UL data belongs to a logical channel with higher priority than the priority of any logical channel containing available UL data which belong to any LCG.

In an embodiment of the fifth solution, a BSR is triggered when UL data, for a logical channel which belongs to a specific LCG, becomes available to the MAC entity where the UL data belongs to a logical channel with a priority higher than a threshold and where the threshold is configured for the specific LCG. Here, the LCG is configured to allow such BSR. The BSR is only triggered if the BSR can be transmitted in a PUSCH transmission occasion of a CG that is configured to convey such BSR.

If there are multiple PUSCH transmission occasions associated with an UL transmission (the UL transmission could be a dynamically scheduled UL transmission or an UL transmission based on a configured grant), the BSR is sent on the first (or last or pre-configured) PUSCH transmission occasion of the UL transmission.

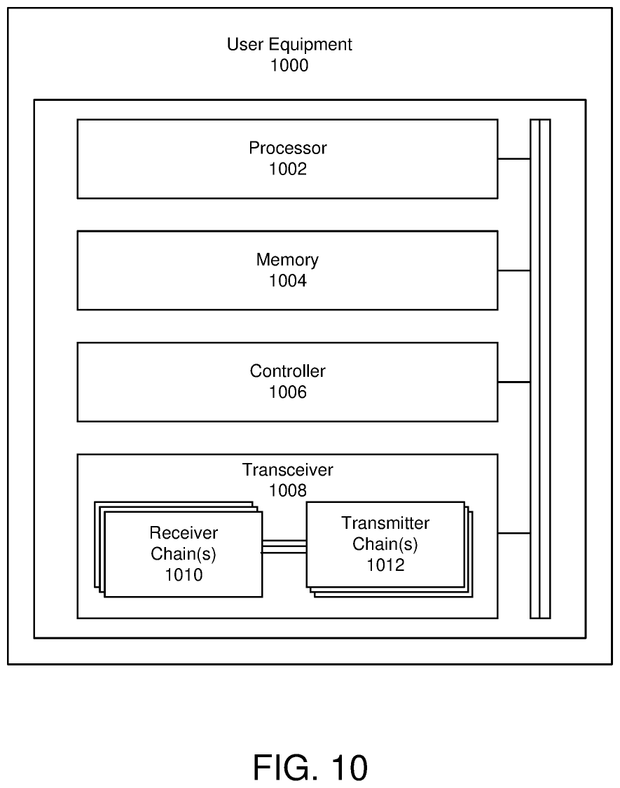

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, a Field Programable Gate Array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the UE functions described herein (e.g., executing, by the processor 1002, instructions stored in the memory 1004). For example, the processor 1002 may support wireless communication at the UE 1000 in accordance with examples as disclosed herein. The UE 1000 may be configured to support a means for receiving a CG configuration for UL transmissions in periodic UL resources corresponding to a plurality of CG periods.

The UE 1000 may be configured to support a means for determining a first set of the plurality of CG periods, where a respective UL resource in a CG period of the first set of the plurality of CG periods includes a plurality of PUSCH transmission occasions, and where at least one CG period of a remainder of the plurality of CG periods includes a single PUSCH transmission occasion.

The UE 1000 may be configured to support a means for transmitting a TB in a particular PUSCH transmission occasion. In some implementations, the UE 1000 may be configured to transmit different TBs in different PUSCH transmission occasions.

In some implementations, the first method includes determining a second set of the plurality of CG periods, where a corresponding UL resource in a CG period of the second set of the plurality of CG periods includes a different number of PUSCH transmission occasions than the respective UL resource in the respective CG period of the first set. In certain implementations, the corresponding UL resource in a CG period of the second set of the plurality of CG periods includes a single PUSCH transmission occasion.

In some implementations, the UE 1000 may be configured to transmit, to a mobile communication network, an indication of a set of unused PUSCH transmission occasions of a first UL resource in a first CG period. In certain implementations, to transmit the indication, the UE 1000 may be configured to transmit UCI multiplexed in a first PUSCH transmission occasion of the first UL resource. In further implementations, the indication is absent from a last PUSCH transmission occasion of the first UL resource.

In some implementations, the UE 1000 may be configured to receive DCI scheduling an UL transmission in at least a part of one PUSCH transmission occasion of the set of unused PUSCH transmission occasions. In such implementations, the UE 1000 may be configured to transmit the UL transmission in response to a time between the transmission of the indication and the reception of the DCI satisfying (e.g., being greater than) a threshold amount.

In some implementations, the first UL resource is associated with a high priority transmission. In such implementations, the UE 1000 may be configured to determine that a second UL resource overlaps with an unused PUSCH transmission occasion of the set of unused PUSCH transmission occasions, the second UL resource associated with a lower priority transmission, and to transmit the lower priority transmission in the second UL resource in response to a time between the transmission of the indication and the second UL resource satisfying (e.g., being greater than) a threshold amount.

In some implementations, the UE 1000 may be configured to determine that a number of unused resources corresponding to the set of unused PUSCH transmission occasions satisfies (e.g., is smaller than) a first threshold amount. In such implementations, the UE 1000 may be configured to transmit a CSI report in a particular UL resource of the set of unused resources in response to a time between the transmission of the indication and the particular UL resource satisfying (e.g., being greater than) a second threshold amount.

In some implementations, the UE 1000 may be configured to transmit, to a mobile communication network, a buffer status report in a first PUSCH transmission occasion of a first UL resource in a first CG period. In certain implementations, the buffer status report indicates an amount (i.e., a volume) of available UL data that is available for transmission at a buffer (e.g., of a MAC entity) of the UE 1000, the available UL data corresponding to a configured logical channel group.

In some implementations, to determine the first set of the plurality of CG periods, the UE 1000 may be configured to utilize a configured bitmap. In certain implementations, the configured bitmap indicates a semi-static pattern of PUSCH transmission occasions for a group of contiguous CG periods. In certain implementations, the configured bitmap corresponds to a video-frame arrival rate and a maximum tolerable delay of packet arrival.

The controller 1006 may manage input and output signals for the UE 1000. The controller 1006 may also manage peripherals not integrated into the UE 1000. In some implementations, the controller 1006 may utilize an operating system (OS) such as iOS®, ANDROID®, WINDOWS®, or other operating systems (OSes). In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receiving signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

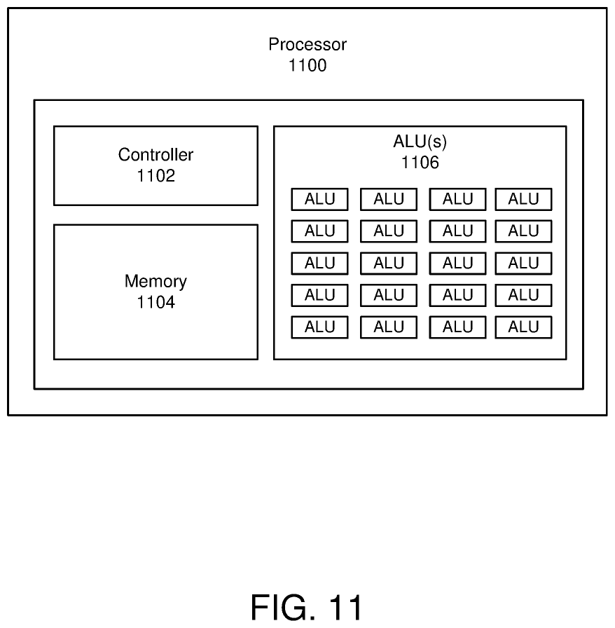

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. For example, the processor 1100 may perform one or more of the UE functions described herein. The processor 1100 may be configured to or operable to support a means for receiving a CG configuration for UL transmissions in periodic UL resources corresponding to a plurality of CG periods.

The processor 1100 may be configured to support a means for determining a first set of the plurality of CG periods, where a respective UL resource in a CG period of the first set of the plurality of CG periods includes a plurality of PUSCH transmission occasions, and where at least one CG period of a remainder of the plurality of CG periods includes a single PUSCH transmission occasion.

The processor 1100 may be configured to support a means for transmitting a TB in a particular PUSCH transmission occasion. In some implementations, the processor 1100 may be configured to transmit different TBs in different PUSCH transmission occasions.

In some implementations, the first method includes determining a second set of the plurality of CG periods, where a corresponding UL resource in a CG period of the second set of the plurality of CG periods includes a different number of PUSCH transmission occasions than the respective UL resource in the respective CG period of the first set. In certain implementations, the corresponding UL resource in a CG period of the second set of the plurality of CG periods includes a single PUSCH transmission occasion.

In some implementations, the processor 1100 may be configured to transmit, to a mobile communication network, an indication of a set of unused PUSCH transmission occasions of a first UL resource in a first CG period. In certain implementations, to transmit the indication, the processor 1100 may be configured to transmit UCI multiplexed in a first PUSCH transmission occasion of the first UL resource. In further implementations, the indication is absent from a last PUSCH transmission occasion of the first UL resource.

In some implementations, the processor 1100 may be configured to receive DCI scheduling an UL transmission in at least a part of one PUSCH transmission occasion of the set of unused PUSCH transmission occasions. In such implementations, the processor 1100 may be configured to transmit the UL transmission in response to a time between the transmission of the indication and the reception of the DCI satisfying (e.g., being greater than) a threshold amount.

In some implementations, the first UL resource is associated with a high priority transmission. In such implementations, the processor 1100 may be configured to determine that a second UL resource overlaps with an unused PUSCH transmission occasion of the set of unused PUSCH transmission occasions, the second UL resource associated with a lower priority transmission, and to transmit the lower priority transmission in the second UL resource in response to a time between the transmission of the indication and the second UL resource satisfying (e.g., being greater than) a threshold amount.

In some implementations, the processor 1100 may be configured to determine that a number of unused resources corresponding to the set of unused PUSCH transmission occasions satisfies (e.g., is smaller than) a first threshold amount. In such implementations, the processor 1100 may be configured to transmit a CSI report in a particular UL resource of the set of unused resources in response to a time between the transmission of the indication and the particular UL resource satisfying (e.g., being greater than) a second threshold amount.

In some implementations, the processor 1100 may be configured to transmit, to a mobile communication network, a buffer status report in a first PUSCH transmission occasion of a first UL resource in a first CG period. In certain implementations, the buffer status report indicates an amount (i.e., a volume) of available UL data that is available for transmission at a buffer (e.g., of a MAC entity) of the processor 1100, the available UL data corresponding to a configured logical channel group.

In some implementations, to determine the first set of the plurality of CG periods, the processor 1100 may be configured to utilize a configured bitmap. In certain implementations, the configured bitmap indicates a semi-static pattern of PUSCH transmission occasions for a group of contiguous CG periods. In certain implementations, the configured bitmap corresponds to a video-frame arrival rate and a maximum tolerable delay of packet arrival.

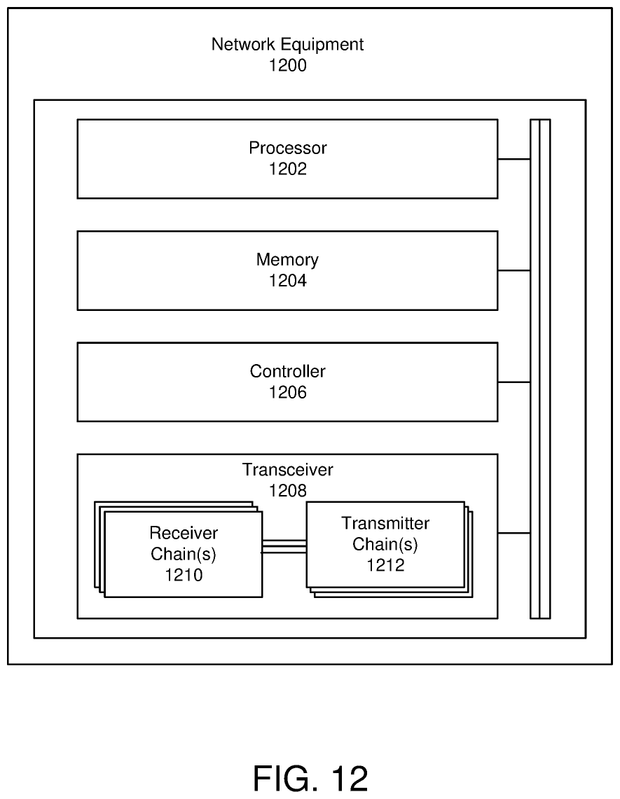

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to support a means for determining a CG configuration for UL transmissions in periodic UL resources corresponding to a plurality of CG periods and a means for transmitting the CG configuration to a UE.

In various implementations, the CG configuration includes a first set of the plurality of CG periods, where a respective UL resource in a respective CG period of the first set of the plurality of CG periods includes a plurality of PUSCH transmission occasions, and where at least one CG period of a remainder of the plurality of CG periods includes a single PUSCH transmission occasion.

In some implementations, the CG configuration includes a second set of the plurality of CG periods, where a corresponding UL resource in a CG period of the second set of the plurality of CG periods includes a different number of PUSCH transmission occasions than the respective UL resource in the respective CG period of the first set. In certain implementations, the corresponding UL resource in a CG period of the second set of the plurality of CG periods includes a single PUSCH transmission occasion.

The NE 1200 may be configured to support a means for receiving, from the UE, different TBs in different PUSCH transmission occasions. In some implementations, the second method includes receiving, from the UE, an indication of a set of unused PUSCH transmission occasions of a first UL resource in a first CG period.

In certain implementations, to receive the indication, the NE 1200 may be configured to receive UCI multiplexed in a first PUSCH transmission occasion of the first UL resource. In further implementations, the indication is absent from a last PUSCH transmission occasion of the first UL resource.

In some implementations, the NE 1200 may be configured to transmit DCI that schedules an UL transmission in at least a part of one PUSCH transmission occasion of the set of unused PUSCH transmission occasions. In such embodiments, the NE 1200 may be configured to receive the UL transmission in response to a time between the reception of the indication and the transmission of the DCI satisfying (e.g., being greater than) a threshold amount.

In some implementations, the first UL resource is associated with a high priority transmission, where the NE 1200 may be configured to receive, from the UE, a lower priority transmission in a second UL resource in response to a time between the reception of the indication and the second UL resource satisfying (e.g., being greater than) a threshold amount. In such implementations, the second UL resource overlaps with an unused PUSCH transmission occasion of the set of unused PUSCH transmission occasions, the second UL resource associated with the lower priority transmission.

In some implementations, the NE 1200 may be configured to receive a CSI report in a particular UL resource of the set of unused resources in response to a time between the reception of the indication and the particular UL resource satisfying (e.g., being greater than) a second threshold amount and in response to a number of unused resources corresponding to the set of unused PUSCH transmission occasions satisfying (e.g., being smaller than) a first threshold amount.

In some implementations, the NE 1200 may be configured to receive, from the UE, a buffer status report in a first PUSCH transmission occasion of a first UL resource in a first CG period. In certain implementations, the buffer status report indicates an amount (i.e., a volume) of available UL data that is available for transmission at a buffer (e.g., of a MAC entity) of the UE, the available UL data corresponding to a configured logical channel group.

In some implementations, the NE 1200 may be configured to provide the UE with a configured bitmap useable to determine the first set of the plurality of CG periods. In certain implementations, the configured bitmap indicates a semi-static pattern of PUSCH transmission occasions for a group of contiguous CG periods. In certain implementations, the configured bitmap corresponds to a video-frame arrival rate and a maximum tolerable delay of packet arrival.

The controller 1206 may manage input and output signals for the NE 1200. The controller 1206 may also manage peripherals not integrated into the NE 1200. In some implementations, the controller 1206 may utilize an OS such as iOS®, ANDROID®, WINDOWS®, or other OSes. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receiving signal and obtain the transmitted data by reversing the modulation technique applied during transmission of the signal. The receiver chain 1210 may include at least one decoder for decoding and processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

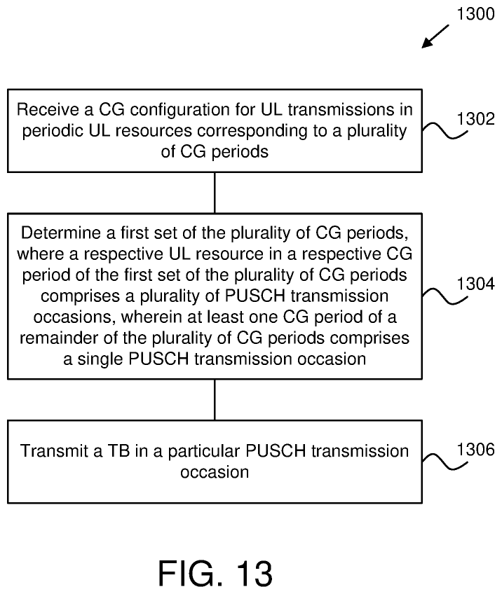

FIG. 13 illustrates a flowchart of a method 1300 in accordance with aspects of the present disclosure. The operations of the method 1300 may be implemented by a UE as described herein. In some implementations, the UE may execute a set of instructions to control the function elements of the UE to perform the described functions.

At Step 1302, the method 1300 may include receiving a CG configuration for UL transmissions in periodic UL resources corresponding to a plurality of CG periods. The operations of Step 1302 may be performed in accordance with examples as described herein. In some implementations, aspects of the operations of Step 1302 may be performed by a UE as described with reference to FIG. 10.

At Step 1304, the method 1300 may include determining a first set of the plurality of CG periods, where a respective UL resource in a respective CG period of the first set of the plurality of CG periods comprises a plurality of PUSCH transmission occasions, wherein at least one CG period of a remainder of the plurality of CG periods comprises a single PUSCH transmission occasion. The operations of Step 1304 may be performed in accordance with examples as described herein. In some implementations, aspects of the operations of Step 1304 may be performed by a UE as described with reference to FIG. 10.

At Step 1306, the method 1300 may include transmitting a TB in a particular PUSCH transmission occasion. The operations of Step 1306 may be performed in accordance with examples as described herein. In some implementations, aspects of the operations of Step 1306 may be performed a UE as described with reference to FIG. 10.

It should be noted that the method 1300 described herein describes one possible implementation, and that the operations and the steps may be rearranged or otherwise modified and that other implementations are possible.

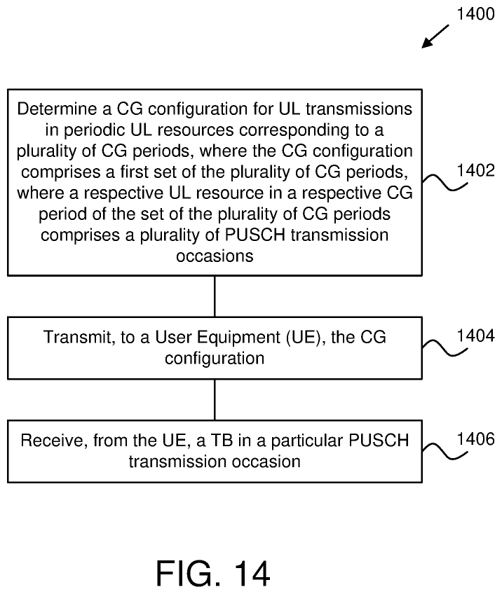

FIG. 14 illustrates a flowchart of a method 1400 in accordance with aspects of the present disclosure. The operations of the method 1400 may be implemented by a NE as described herein. In some implementations, the NE may execute a set of instructions to control the function elements of the NE to perform the described functions.

At Step 1402, the method 1400 may include determining a CG configuration for UL transmissions in periodic UL resources corresponding to a plurality of CG periods, where the CG configuration comprises a first set of the plurality of CG periods, where a respective UL resource in a respective CG period of the set of the plurality of CG periods comprises a plurality of PUSCH transmission occasions. The operations of Step 1402 may be performed in accordance with examples as described herein. In some implementations, aspects of the operations of Step 1402 may be performed by a NE as described with reference to FIG. 12.

At Step 1404, the method 1400 may include transmitting, to a User Equipment (UE), the CG configuration. The operations of Step 1404 may be performed in accordance with examples as described herein. In some implementations, aspects of the operations of Step 1404 may be performed by a NE as described with reference to FIG. 12.

At Step 1406, the method 1400 may include receiving, from the UE, a TB in a particular PUSCH transmission occasion. The operations of Step 1406 may be performed in accordance with examples as described herein. In some implementations, aspects of the operations of Step 1406 may be performed a NE as described with reference to FIG. 12.

It should be noted that the method 1400 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a configured grant (CG) configuration for one or more uplink (UL) transmissions in a plurality of periodic UL resources corresponding to a set of CG periods;
determine a first subset of the set of CG periods and a second subset of the set of CG periods based on the CG configuration, wherein each CG period of the first subset of the set of CG periods comprises a plurality of physical uplink shared channel (PUSCH) transmission occasions, and wherein each CG period of the second subset of the set of CG periods comprises a single PUSCH transmission occasion; and
transmit a transport block (TB) during a particular PUSCH transmission occasion associated with the first subset of the set of CG periods.

2. The UE of claim 1, wherein the at least one processor is configured to cause the UE to determine a third subset of the set of CG periods based on the CG configuration, wherein a corresponding CG period of the third subset of the set of CG periods comprises a different number of PUSCH transmission occasions than a respective CG period of the first subset of the set of CG periods.

3. The UE of claim 1, wherein the at least one processor is configured to cause the UE to transmit different TBs in different PUSCH transmission occasions associated with the first subset of the set of CG periods.

4. The UE of claim 1, wherein the plurality of PUSCH transmission occasions of a respective CG period comprises a set of unused PUSCH transmission occasions, and wherein the at least one processor is configured to cause the UE to transmit an indication of the set of unused PUSCH transmission occasions.

5. The UE of claim 4, wherein the respective CG period is associated with a high priority transmission, wherein the at least one processor is configured to cause the UE to:
determine that an UL resource overlaps with an unused PUSCH transmission occasion of the set of unused PUSCH transmission occasions, wherein the UL resource is associated with a lower priority transmission; and
transmit the lower priority transmission in the UL resource, wherein a time between the transmission of the indication and the UL resource is greater than a threshold amount.

6. The UE of claim 1, wherein the at least one processor is configured to cause the UE to determine the first subset of the set of CG periods based on a configured bitmap.

7. The UE of claim 6, wherein the configured bitmap indicates a semi-static pattern of PUSCH transmission occasions for a group of contiguous CG periods belonging to the set of CG periods.

8. A method performed by a user equipment (UE), the method comprising:
receiving a configured grant (CG) configuration for uplink (UL) transmissions in periodic UL resources corresponding to a set of CG periods;
determining a first subset of the set of CG periods, wherein a respective CG period of the first subset of the set of CG periods comprises a plurality of physical uplink shared channel (PUSCH) transmission occasions, and wherein each CG period of the second subset of the set of CG periods comprises a single PUSCH transmission occasion; and
transmitting a transport block (TB) during a particular PUSCH transmission occasion associated with the first subset of the set of CG periods.

9. A base station for wireless communication, comprising:
at least one memory; and
at least one processor coupled with the at least one memory and configured to cause the base station to:
transmit, to a user equipment (UE), a configured grant (CG) configuration for uplink (UL) transmissions in periodic UL resources corresponding to a set of CG periods,
wherein the CG configuration indicates a first subset of the set of CG periods and a second subset of the set of CG periods, wherein a each CG period of the first subset of the set of CG periods comprises a plurality of physical uplink shared channel (PUSCH) transmission occasions, and wherein each CG period of the second subset of the set of CG periods comprises a single PUSCH transmission occasion; and
receive, from the UE, a transport block (TB) during a particular PUSCH transmission occasion associated with the first subset of the set of CG periods.

10. The base station of claim 9, wherein the CG configuration further indicates a third subset of the set of CG periods, wherein a corresponding CG period of the third subset of the set of CG periods comprises a different number of PUSCH transmission occasions than a respective CG period of the first subset of the set of CG periods.

11. The base station of claim 9, wherein the at least one processor is configured to cause the base station to receive, from the UE, different TBs in different PUSCH transmission occasions associated with the first subset of the set of CG periods.

12. The base station of claim 9, wherein the plurality of PUSCH transmission occasions of a respective CG period comprises a set of unused PUSCH transmission occasions, and wherein the at least one processor is configured to cause the base station to receive, from the UE, an indication of the set of unused PUSCH transmission occasions.

13. The base station of claim 12, wherein, to receive the indication, the at least one processor is configured to cause the base station to receive uplink control information (UCI) multiplexed in a first PUSCH transmission occasion of the respective CG period, and wherein the indication is absent from a last PUSCH transmission occasion of the respective CG period.

14. The base station of claim 12, wherein the at least one processor is configured to cause the base station to:
transmit downlink control information (DCI) scheduling an UL transmission in at least a part of one PUSCH transmission occasion of the set of unused PUSCH transmission occasions; and
receive the UL transmission based on a time between the reception of the indication and the transmission of the DCI being greater than a threshold amount.

15. The base station of claim 12, wherein the respective CG period is associated with a high priority transmission, wherein the at least one processor is configured to cause the base station to:
receive, from the UE, a lower priority transmission in an second-UL resource that overlaps with an unused PUSCH transmission occasion of the set of unused PUSCH transmission occasions,
wherein a time between the reception of the indication and the UL resource is greater than a threshold amount.

16. The base station of claim 12, wherein the at least one processor is configured to cause the base station to:
receive a CSI report in a particular UL resource associated with the set of unused PUSCH transmission occasions,
wherein a time between the reception of the indication and the particular UL resource being greater than a threshold time, and
wherein a number of unused resources corresponding to the set of unused PUSCH transmission occasions is smaller than a first threshold number.

17. The base station of claim 9, wherein the at least one processor is configured to cause the base station to receive, from the UE, a buffer status report in a first PUSCH transmission occasion of a respective CG period.

18. The base station of claim 9, wherein the at least one processor is configured to cause the base station to configure the UE with a bitmap that indicates the first subset of the set of CG periods.

19. The base station of claim 18, wherein the configured bitmap indicates a semi-static pattern of PUSCH transmission occasions for a group of contiguous CG periods belonging to the set of CG periods.

20. A method performed by a base station, the method comprising:
transmitting, to a user equipment (UE), a configured grant (CG) configuration for uplink (UL) transmissions in periodic UL resources corresponding to a set of CG periods,
wherein the CG configuration indicates a first subset of the set of CG periods and a second subset of the set of CG periods, wherein a each CG period of the first subset of the set of CG periods comprises a plurality of physical uplink shared channel (PUSCH) transmission occasions, and wherein each CG period of the second subset of the set of CG periods comprises a single PUSCH transmission occasion; and
receiving, from the UE, a transport block (TB) during a particular PUSCH transmission occasion associated with the first subset of CG periods.
